(19) United States
(12) Patent Application Publication
(10) Pub. No.: US 2018/0286000 A1
(43) Pub. Date: Oct. 4, 2018

(54) Identity Management for Offline User Data

(71) Applicant: AT&T Intellectual Property I, L.P., Atlanta, GA (US)

(72) Inventors: Michael Joseph Berry, JR., Mansfield, TX (US); Miguel Franco, Plano, TX (US); Matthew Teshera, Sachse, TX (US)

(73) Assignee: AT&T Intellectual Property I, L.P., Atlanta, GA (US)

(21) Appl. No.: 15/476,605

(22) Filed: Mar. 31, 2017

(51) Int. Cl. G06Q 50/26; G06Q 30/02

(52) U.S. Cl. CPC G06Q 50/265; G06Q 30/0269

(57) ABSTRACT

Concepts and technologies are disclosed herein for identity management for first-party data. An identity management system can provide first identifiers and respective trait data associated with each first identifier to a data management platform. The data management platform can assign respective second identifiers to each of the first identifiers. The identity management system can receive third identifiers and corresponding personal identifiable information associated with each third identifier from an advertisement delivery system. Using the personal identifiable information from the advertisement delivery system and personal identifiable information collected by the identity management system, the identity management system can map each of the first identifiers to a respective one of the third identifiers to generate first identifier and third identifier pairs. The identity management system can send the pairs to the data management platform for use in directing targeted information for publication to members of an audience determined by data management platform.

### BACKGROUND

A Data Management Platform (DMP) typically uses online identifiers associated with a user, such as cookie identifiers (IDs), to sync with a cookie ID established by the DMP for the user in order to gather data about the user across different online data sources. DMPs can also ingest offline data about users, which is not associated with an online identifier like a cookie ID. However, in order for a DMP to load offline data about a user, the offline data has to first be matched with data about the user that is associated with an online identifier so that the offline data can then be associated with the online identifier. Such a matching process is usually provided by a safe haven or match provider, such as LIVERAMP or ACXIOM, which attempts to match personal identifiable information (PII), such as the name and/or residential address of the user, provided along with the offline data about the user with PII collected by the match provider that is associated with cookie IDs. In addition to being expensive and time consuming, the match rate resulting from such a process is typically small, such as around 20-50% of the total offline records provided to the match provider. This is because of the limited overlap between the PII provided along with the offline data about the user and the PII collected by the match provider. This leads to a significant loss in the amount of offline data associated with the user that can then be loaded to the DMP for processing.

### SUMMARY

The present disclosure is directed to identity management for offline user data, and specifically for identity management for offline first-party data. As used herein, “first-party data” refers to any piece of data collected by entities such as service providers, businesses and retailers directly from their subscribers, clients, visitors, audiences and customers, both offline and online. As used herein, “offline first-party data” refers to first-party data that originates from activities that are performed by subscribers, clients, visitors, audiences and customers without the use of a data network, such as the Internet. As used herein “online first-party data” refers to first-party data that originates from activities that are performed by subscribers, clients, visitors, audiences and customers with the use of a data network, such as the Internet, and is associated with an online identifier, such as a cookie ID. Offline first-party data can include viewership data of content distributed via satellite, cable or terrestrial broadcast; transaction data collected via an in-store point-of-sale device and/or via an over-the-phone purchase; customer data from an offline Customer Relationship Management (CRM) system; information about how a mobile communications device is being used including, for example, usage data of applications executing on the mobile communications device, location information associated with the mobile communications device, and information about interactions with contacts using the mobile communications device; and any other data originating from activities performed by subscribers, clients, visitors, audiences and customers without the use of a data network, such as the Internet.

The offline first-party data can include personal identifiable information (PII). As used herein, “PII” refers to any information that can be used on its own or with other information to identify, contact or locate an individual person. PII can include information about a person such as a name, residential address(es), email address(es), phone number(s), social security number, date of birth, passport number, driver's license number, biometric information, credit card number(s), genetic information, or any other information that can be used to identify, contact or locate an individual person. According to embodiments, the offline first-party data can be used by an entity that collects the data to generate one or more first-party data sets for each of the entity's subscribers, clients, visitors, audiences and customers. The first-party data sets can include traits and attributes deduced from the offline first-party data corresponding to each of the entity's subscribers, clients, visitors, audiences and customers.

Also, as used herein, a “first identifier” or a “first ID” refers to a set of characters, numbers, letters and/or symbols that an entity such as a service provider, business or retailer assigns to a particular person or an account of the particular person with whom the entity is doing business. For instance, the first identifier can include an account number assigned to an account for each specific service and/or product provided by an entity to a person or household of the person or to an account covering all of the services and/or products provided by the entity to a person or household of the person based on a business relationship established between the person (e.g., and account holder) and the entity. According to embodiments, offline first-party data collected by an entity for a customer, as well as the first-party data sets including attributes and traits about the customer deduced by the entity from the first-party data for the customer, are associated with and maintained based on the first identifier assigned to the customer or the customer's account.

As used herein, a “second identifier” refers to a set of characters, numbers, letters and/or symbols that a DMP assigns to each first identifier, or each first identifier for an account, household, and/or account holder, which is provided to the DMP by an identity management system associated with an entity such as a service provider, business or retailer that generated the first identifiers. As used herein a “third identifier” or “third ID” refers to a set of characters, numbers, letters and/or symbols assigned to respective PII gathered by an advertisement delivery system. According to embodiments, the identity management system receives the third IDs and corresponding PII from the advertisement delivery system and matches the PII provided by the advertisement delivery system with PII collected by the entity in order to generate a bridge file mapping the third IDs provided by the advertisement delivery system with the first IDs generated by the entity.

According to one aspect of the concepts and technologies disclosed herein, a method for managing offline first-party data is disclosed. The method can include operations performed by an identity management system. According to the method, the identity management system can provide to a data management platform (DMP) first identifiers assigned to accounts managed by the identity management system and can also provide respective trait data associated with each of the first identifiers. The respective trait data associated with a first identifier of the first identifiers can correspond to a user and/or a household of the user associated with an account managed by the identity management system. The trait data can be deduced from offline first-party data that is collected from the user and/or household of the user. The offline first-party data for a user/household of the user, which can include PII, can be associated and maintained based on the first identifier assigned to the user/household of the user. As discussed further below, a second identifier can be assigned by the DMP to each of the first identifiers provided by the identity management system and the respective trait data associated with each of the first identifiers.

The method can further include the identity management system receiving a plurality of third identifiers and corresponding PII from an advertisement delivery system. The identity management system can use the PII collected from the users and the PII provided by the advertisement delivery system to map the first identifiers assigned to the users/households of the users to the third identifiers provided by the advertisement delivery system determined to represent the same users/households of the users. According to embodiments, the identity management system maps the first identifiers to the third identifiers based on commonalities determined by the identity management system between the PII collected from the users and the PII provided by the advertisement delivery system. These commonalities between the sets of PII can include, for example, a common residential address, a common phone/email number, and/or a common name. The identity management system can create pairs of first identifiers and third identifiers that are determined to be related based on the commonalities identified in the sets of PII. The identity management system can create a bridge file for each pair of first identifier and third identifier. According to embodiments, the PII associated with the first identifier and the PII associated with the third identifier are excluded from the bridge file, allowing the bridge file to provide an anonymous connection between the first identifier and the third identifier.

The identity management system can provide the bridge file to the DMP. The DMP can use the bridge file from the identity management system to map the third identifiers provided by the advertisement delivery system to the second identifiers assigned by the DMP that represent the same users/households of the users as the third identifiers. The DMP can use the first identifiers to map the third identifiers to the second identifiers that represent the same users as the first identifiers since both the second identifiers and third identifiers have been previously paired with corresponding first identifiers. The DMP can create a bridge file including each pairing of the second identifier and the third identifier that is determined to represent the same user/household of the user. Once the DMP identifies a segment or audience of the second identifiers to which to direct targeted information based, at least in part, on the trait and/or attribute data corresponding to the first identifiers mapped to the second identifiers, the DMP can use the bridge file of pairings between the second and third identifiers to determine the third identifiers that map to the second identifiers of the segment. The DMP can communicate these third identifiers, which are recognized by the advertisement delivery system, to the advertisement delivery system for use in determining where the advertisement delivery system should direct the targeted information. The respective trait data used for determining the audience for the targeted information can include product information, service information, geolocation information, demographic information, preferences information, genre information, behavioral information, psychographic information, and opt-in advertising information related to an account user, account holder or household member for each respective first-party account.

According to one aspect of the concepts and technologies disclosed herein, an identity management system is disclosed. The system can include a processor and a memory. The memory can store computer-executable instructions that, when executed by the processor, cause the processor and the identity management system to perform operations. These operations can include providing first identifiers assigned to accounts managed by the identity management system and also trait data associated with each of the first identifiers to a DMP. The respective trait data associated with a first identifier of the identifiers can correspond to a user and/or a household of the user associated with an account managed by the identity management system. A second identifier can be assigned by the DMP to each of the first identifiers provided by the identity management system and the respective trait data associated with each of the first identifiers.

The operations can further include the identity management system receiving a plurality of third identifiers and corresponding PII from an advertisement delivery system. The identity management system can use the PII collected from the users and the PII provided by the advertisement delivery system to map the first identifiers assigned to the users/households of the users to the third identifiers provided by the advertisement delivery system determined to represent the same users/households of the users. In addition, the identity management system performs operations for mapping the first identifiers to the third identifiers based on commonalities determined by the identity management system between the PII collected from the users and the PII provided by the advertisement delivery system. These commonalities between the sets of PII can include, for example, a common residential address, a common phone/email number, and/or a common name. The identity management system can create pairs of first identifiers and third identifiers that are determined to be related based on the commonalities identified in the sets of PII. The identity management system can perform further operations including creating a bridge file for each pair of first identifier and third identifier. According to embodiments, the PII associated with the first identifier and the PII associated with the third identifier are excluded from the bridge file, allowing the bridge file to provide an anonymous connection between the first identifier and the third identifier.

The identity management system can perform operations for providing the bridge file to the DMP. The DMP can use the bridge file from the identity management system to map the third identifiers provided by the advertisement delivery system to the second identifiers assigned by the DMP that represent the same users/households of the users as the third identifiers. The DMP can use the first identifiers to map the third identifiers to the second identifiers that represent the same users as the first identifiers since both the second identifiers and third identifiers have been previously paired with corresponding first identifiers. The DMP can create a bridge file including each pairing of second identifier and third identifier that is determined to represent the same user/household of the user. Once the DMP identifies a segment or audience of the second identifiers to which to direct targeted information based, at least in part, on the trait and/or attribute data corresponding to the first identifiers mapped to the second identifiers, the DMP can use the bridge file of pairings between the second and third identifiers to determine the third identifiers that map to the second identifiers of the segment. The DMP can communicate these third identifiers, which are recognized by the advertisement delivery system, to the advertisement delivery system for use in determining where the advertisement delivery system should direct the targeted information. In some embodiments, the respective trait data for determining publication of the targeted information can include product information, service information, geolocation information, demographic information, preferences information, genre information, behavioral information, psychographic information, and opt-in advertising information.

According to one aspect of the concepts and technologies disclosed herein, a computer storage medium having computer-executable instructions stored thereon is disclosed that, when executed by a processor of an identity management system, cause the processor to perform various operations. The operations can include providing first identifiers assigned to accounts managed by the identity management system and also respective trait data associated with each of the first identifiers to a DMP. The respective trait data associated with a first identifier of the identifiers can correspond to a user and/or a household of the user associated with an account managed by the identity management system. The trait data can be deduced from offline first-party data that is collected from the user and/or household of the user. The offline first-party data for a user/household of the user, which can include PII, can be associated and maintained based on the first identifier assigned to the user/household of the user. A second identifier can be assigned by the DM′ to each of the first identifiers provided by the identity management system and the respective trait data associated with each of the first identifiers.

The operations can further include the identity management system receiving a plurality of third identifiers and corresponding PII from an advertisement delivery system. The identity management system can use the PII collected from the users and the PII provided by the advertisement delivery system to map the first identifiers assigned to the users/households of the users to the third identifiers provided by the advertisement delivery system determined to represent the same users/households of the users. In addition, the identity management system performs operations for mapping the first identifiers to the third identifiers based on commonalities determined by the identity management system between the PII collected from the users and the PII provided by the advertisement delivery system. These commonalities between the sets of PII can include, for example, a common residential address, a common phone/email number, and/or a common name. The identity management system can create pairs of first identifiers and third identifiers that are determined to be related based on the commonalities identified in the sets of PII. The identity management system can perform further operations including creating a bridge file for each pair of first identifier and third identifier. According to embodiments, the PII associated with the first identifier and the PII associated with the third identifier are excluded from the bridge file, allowing the bridge file to provide an anonymous connection between the first identifier and the third identifier.

The identity management system can perform operations for providing the bridge file to the DMP. The DMP can use the bridge file from the identity management system to map the third identifiers provided by the advertisement delivery system to the second identifiers assigned by the DMP that represent the same users/households of the users as the third identifiers. The DMP can use the first identifiers to map the third identifiers to the second identifiers that represent the same users as the first identifiers since both the second identifiers and third identifiers have been previously paired with corresponding first identifiers. The DMP can create a bridge file including each pairing of second identifier and third identifier that is determined to represent the same user/household of the user. Once the DMP identifies a segment or audience of the second identifiers to which to direct targeted information based, at least in part, on the trait and/or attribute data corresponding to the first identifiers mapped to the second identifiers, the DMP can use the bridge file of pairings between the second and third identifiers to determine the third identifiers that map to the second identifiers of the segment. The DMP can communicate these third identifiers, which are recognized by the advertisement delivery system, to the advertisement delivery system for use in determining where the advertisement delivery system should direct the targeted information. In some embodiments, the respective trait data for determining publication of the targeted information can include product information, service information, geolocation information, demographic information, preferences information, genre information, behavioral information, psychographic information, and opt-in advertising information.

Other systems, methods, and/or computer program products for managing offline identity information and for delivering targeted advertising information according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a system diagram illustrating an illustrative operating environment and network for various embodiments of the concepts and technologies described herein.

FIG. 2 schematically illustrates aspects of deducing trait and/or attribute data from first-party data according to an illustrative embodiment of the concepts and technologies described herein.

FIG. 3 is a flow diagram showing aspects of a method for managing identity information according to an illustrative embodiment of the concepts and technologies described herein.

FIG. 4 schematically illustrates pairing first and third identifiers according to personal identifiable information according to an illustrative embodiment of the concepts and technologies described herein.

FIG. 5 schematically illustrates example features of a method for managing identity information including first identifier records, a first bridge file, a second bridge file and a table according to an illustrative embodiment of the concepts and technologies described therein.

FIG. 6 is a flow diagram showing aspects of a method for managing identity information according to an illustrative embodiment of the concepts and technologies described herein.

FIG. 7 is a flow diagram showing aspects of a method for determining an audience for targeted information according to an illustrative embodiment of the concepts and technologies described herein.

FIG. 8 is a block diagram illustrating an example computer system configured to manage offline first-party data according to some illustrative embodiments of the concepts and technologies described herein.

FIG. 9 is a network diagram illustrating a network environment for various embodiments of the concepts and technologies described herein.

### DETAILED DESCRIPTION

The following detailed description is directed to methods and systems for identity management of user data, and more particularly identity management of offline first-party data. In order for a DMP to load offline data about a user, the offline data typically has to first be matched with data about the user that is associated with an online identifier so that the offline data can then be associated with the online identifier. Such a matching process is usually provided by a safe haven or match provider, such as LIVERAMP or ACXIOM, which attempts to match personal identifiable information (PH), such as the name and/or residential address of the user, provided along with the offline data about the user with PII collected by the match provider that is associated with cookie IDs. In addition to being expensive and time consuming, the match rate resulting from such a matching process is typically small, such as around 20-50% of the total offline records provided to the match provider, because of the limited overlap between the PII provided along with the offline data about the user and the PII collected by the match provider. This leads to a significant loss in the amount of offline data associated with the user that can then be loaded to the DMP for processing. According to aspects of the concepts and technologies discussed herein, an identity management system can manage offline first-party data associated with subscribers, clients, visitors and/or customers (herein collectively referred to as “customers” or “users”) of an entity, such as a service provider, to allow the offline first-party data and/or attributes and traits deduced from the offline first-party data to be loaded to a data management platform (DMP) without the use of a safe haven or match provider and with little to no loss of the data that can be provided to the DMP. The DMP can then use this data to help define audience segments within the data for receiving targeted information associated with the entity.

The disclosed systems, devices and methods can collect offline first-party data provided by each customer of an entity and associate the offline first-party data with a corresponding first identifier generated by the entity and assigned to each customer or account established for the customer by the entity. The offline first-party data can include any type of first-party data that originates from activities that are performed by customers without the use of a data network, such as the Internet. For instance, the offline first-party data can include viewership data of content distributed via satellite, cable, or terrestrial broadcast; transaction data collected via an in-store point-of-sale device and/or via an over-the-phone purchase; customer data from an offline Customer Relationship Management (CRM) system; information about how a mobile communications device is being used including, for example, usage data of applications executing on the mobile communications device, location information associated with the mobile communications device, and information about interactions with contacts using the mobile communications device; and any other data originating from activities performed by subscribers, clients, visitors, audiences and customers without the use of a data network, such as the Internet. The offline first-party data can include PII about each customer including the customer's name, residential address(es), email address(es), phone number(s), social security card number, date of birth, passport number, driver's license number, biometric information, credit card number(s), genetic information, or any other information that can be used to identify, contact or locate an individual person. The systems, devices and methods can also attain third-party consumer data, such as demographic and behavioral data, associated with the customers of the entity from third-party providers in order, for example, to enhance the offline first-party data collected by the entity. Like the offline first-party data, the third-party consumer data can be associated with the first identifier for the customer for which the third-party consumer data is related. All of the data collected and attained for each customer of an entity can be stored in a data repository, such as a data lake or other centralized repository, in association with the corresponding first identifier assigned by the entity to each customer. The data stored in the data repository for each customer can be regularly updated as new and/or modified data associated with a customer is received.

According to embodiments, data associated with each first identifier stored in the data repository can be processed to generate one or more first-party data files corresponding to the respective customer associated with each first identifier. The first-party data files can include traits and/or attributes corresponding to the respective customer that are deduced from the data associated with each first identifier stored in the data repository. The one or more first-party data files generated based on the data associated with each first identifier can also be associated with the corresponding first identifier.

To load the offline first-party data and/or the first-party data files to a DMP, embodiments of identity management system described herein provide the first identifiers of the entity's customers assigned by the entity to the DMP. The DMP can be requested to generate and assign a corresponding second identifier for each of the first identifiers and/or for each of the first identifiers associated with an account, household or account holder. The offline first-party data for each customer and/or the first-party data files generated from the offline first-party data for each customer, all of which are associated with a corresponding first identifier of each customer, can then be loaded to the DMP and matched, using the corresponding first identifier as the key, to a corresponding second identifier assigned by the DMP. Thus, the offline first-party data for each customer can be processed by the DMP instead of just a portion of the data that a safe haven or match provider is able to associate with online identifiers.

DMPs can use advertisement delivery systems to publish targeted information to audiences identified by the DMP for receipt of the targeted information. In order to correctly identify to an advertisement delivery system each user of the audience to which the targeted information should be published, the DMP can provide a corresponding identifier representative of each user to the advertisement delivery system that is recognizable by the advertisement delivery system. According to embodiments described herein, the identity management system can receive third identifiers generated by one or more advertisement delivery systems and PII corresponding to each of the third identifiers from the one or more advertisement delivery systems. The identity management system can compare the PII provided by the advertisement delivery system with the PII from the offline first-party data collected from the customers of the entity for commonalities between the sets of PII. When commonalities are detected, the identity management system can determine that a third identifier corresponding to the PII received from the advertisement delivery system and a first identifier associated with the PII from the offline first-party data found to have some information in common with the PII received from the advertisement delivery system represent the same user and can, accordingly, associate the first identifier with the third identifier to create a first identifier and third identifier pair. The first and third identifier pair can be provided to the DMP and used by the DMP to determine, based on the first identifier, the third identifier assigned by, and therefore recognized by, the advertisement delivery system that corresponds to the second identifier assigned by the DMP to which targeted information is to be published.

While the subject matter described herein is presented in the general context of program modules that execute in conjunction with the execution of an operating system and application programs on an identity management system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

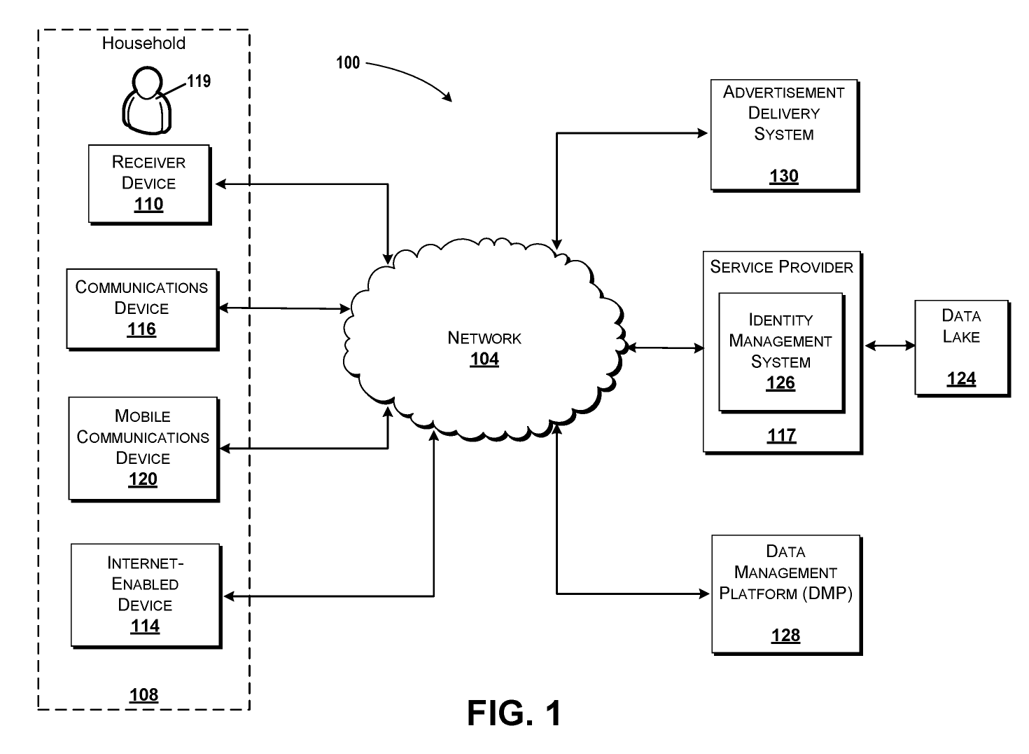

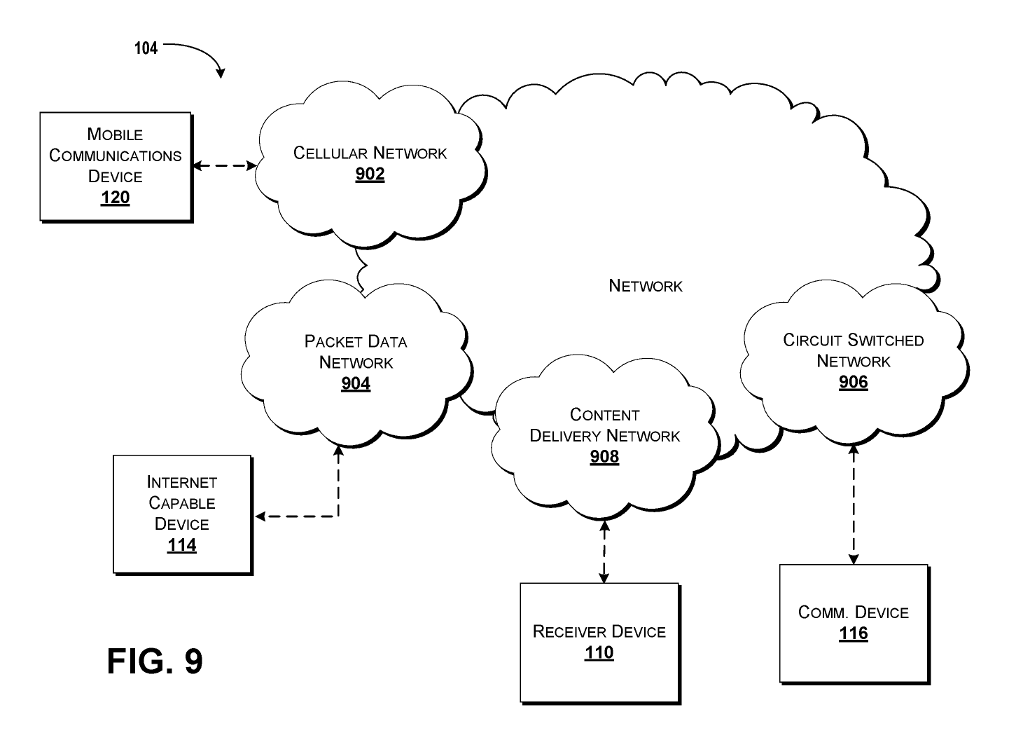

Referring now to FIG. 1, aspects of an operating environment 100 for various embodiments of the concepts and technologies disclosed herein for managing offline first-party data will be described, according to an illustrative embodiment. The operating environment 100 shown in FIG. 1 includes an identity management system 126. The identity management system 126 can operate in communication with and/or as part of a network 104, though this is not necessarily the case. Additional details of the network 104 are illustrated and described below with reference to FIG. 9. According to embodiments, the identity management system 126 is associated with an entity, such as a service provider 117, that provides one or more services and/or products to customers of the service provider 117 via one or more channels including the network 104.

According to various embodiments, the functionality of the identity management system 126 may be provided by one or more server computers, desktop computers, mobile telephones, laptop computers, set-top boxes, other computing systems, and the like. It should be understood that the functionality of the identity management system 126 can be provided by a single device, by two similar devices, and/or by two or more dissimilar devices. For purposes of describing the concepts and technologies disclosed herein, the identity management system 126 is described herein as a server computer (also referred to herein as “identity management server 126”). It should be understood that this embodiment is illustrative, and should not be construed as being limiting in any way.

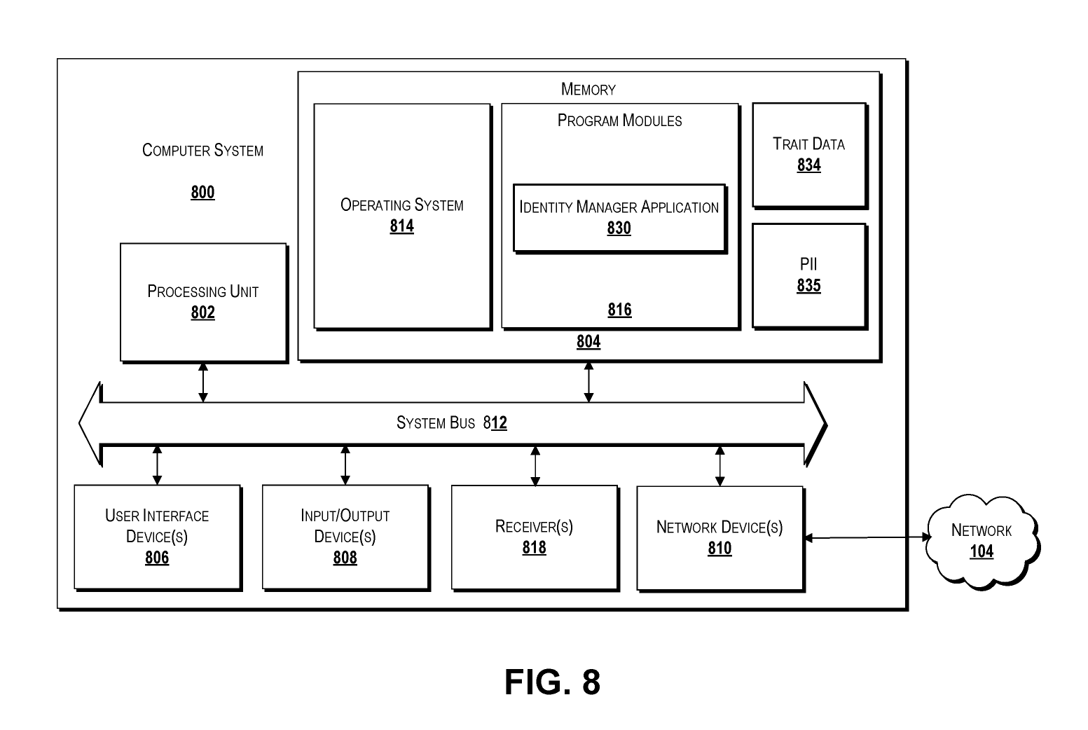

As discussed further below along with FIG. 8, the identity management system 126 can execute an operating system 814 and one or more application programs such as, for example, an identity manager application 830. The operating system 814 is a computer program for controlling the operation of the identity management system 126. The identity manager application 830 is an executable program configured to execute on top of the operating system 814 to provide various functions. The identity manager application 830 can be configured to manage offline first-party data as described further herein.

Although the identity manager application 830 is illustrated as a component of the identity management system 126, it should be understood that the identity manager application 830 can be embodied as or in stand-alone devices or components thereof operating as part of or in communication with the network 104 and/or the identity management system 126. As such, the illustrated embodiment should be understood as being illustrative of only some contemplated embodiments and should not be construed as being limiting in any way.

As shown in FIG. 1, the operating environment 100 also includes one or more devices that receive services provided by the service provider 117 via the network 104. The devices may be associated with a household 108 that includes one or more members, such as a user 119, who has subscribed to one or more of the services provided by the service provider 117. The service provider 117 can establish an account for the user 119 for each service provided to the devices associated with the user 119 and/or the household 108 of the user 119 and/or can establish one account covering all of the services provided to the devices associated with the user 119 and/or the household 108 of the user 119. A first identifier, such as an account number, can be assigned by the service provider 117 to each of the accounts established for the user 119 and/or the household of the user 119, whether that is a separate account for each service or one account covering all services associated with the user 119 and/or the household 108. The first identifier assigned to each account can include a set of characters, numbers, letters and/or symbols that the service provider 117 can use to anonymously represent the user 119, household 108 and/or users associated with an account.

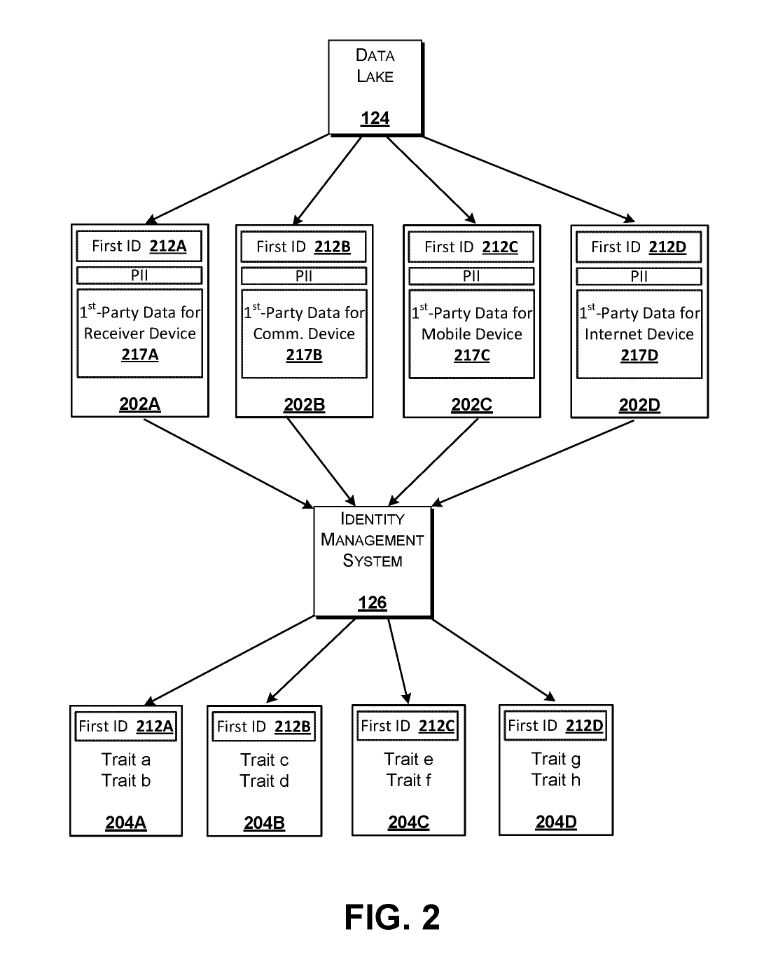

The user 119 and/or other members of the household 108 can provide personal identifiable information (PII) to the service provider 117 in order to establish an account and subscribe to the services provided by the service provider. The PII provided can include a name of the user 119 and/or one or more of the other members of the household 108, residential address(es) associated with the household 108, email address(es) of one or more members of the household 108, phone number(s) of one or more members of the household 108, a social security number of one or more members of the household 108, a date of birth of one or more members of the household 108, a passport number of one or more members of the household 108, a driver's license number of one or more members of the household 108, credit card number(s) of one or more members of the household 108, or any other information that can be used by the service provider to identify, contact or locate one or more members of the household 108. The PII of the one or more members of the household 108 can be associated with the first identifier assigned to each account established for the user 119/household 108 to create records, such as records 202A-202D described further below with reference to FIG. 2, associated with the user 119/household 108. The records including the PII in association with the respective first identifier can be maintained in a data repository, such as a data lake 124, of the service provider 117. As will be described further herein, other data and information collected by the service provider 117 from the user 119 and/or other members of the household 108, also referred to herein as “first-party user data”, can also be associated with the respective first identifier assigned to the account(s) of the user 119/household 108 and included in the records maintained in the data lake 124.

The devices can include a receiver device 110, such as a satellite television receiver, a set-top box device, digital video recorder, or combinations thereof, that can receive signals, such as television signals, via the network 104. The signals can be provided to the receiver device 110 in response to the user 119 subscribing to a television service provided by the service provider 117. According to embodiments, the signals are associated with content that can be displayed or otherwise provided via a display associated with the receiver device 110. The identity management system 126 associated with the service provider 117 can collect viewership data about what content is provided to the receiver device 110. The viewership data collected can be associated with the first identifier assigned to the account established for the user 119/household 108 based on the user 119 subscribing to the television service provided by the service provider 117. The viewership data can be maintained in the data lake 124 in association with the first identifier assigned to the account associated with the television service.

The devices can also include a communications device 116, such as a household telephone, that can send and receive wireline communications according to a telephone service provided by the service provider 117 and subscribed to by the user 119. According to embodiments, the identity management system 126 associated with the service provider 117 collects information about how the communications device 116 is being used, such as information about contacts interacted with using the communications device 116. The information collected about how the communications device 116 is being used can be associated with the first identifier assigned to the account established for the user 119/household 108 based on the user 119 subscribing to the telephone service provided by the service provider 117. The information about how the communications device 116 is being used can be maintained in the data lake 124 in association with the first identifier assigned to the account associated with the telephone service.

The devices can further include a mobile communications device 120, such as a cellular telephone, a user equipment, a mobile terminal, a PDA, a laptop computer, a handheld computer, and combinations thereof, that can send and receive wireless communications via the network 104 according to a wireless communication service provided by the service provider 117 and subscribed to by the user 119. It should be understood that the household 108 can be associated with one or more of the mobile communications devices 120 depending on how many members of the household 108 have one. According to embodiments, the identity management system 126 associated with the service provider 117 collects information about how each of the mobile communications devices 120 is being used, such as usage data of applications executing on each of the mobile communications devices 120, location information associated with each of the mobile communications devices 120, and information about interactions with contacts using each of the mobile communications devices 120. The information collected about how each of the mobile communications devices 120 of the household 108 is being used can be associated with the first identifier assigned to the account established for the user 119/household 108. If the household 108 is associated with more than one mobile communications device 120, the information about how each mobile communications device 120 is being used can further be associated with an identification, such as a telephone number, that uniquely identifies each of the mobile communications devices 120. The information about how each of the mobile communications devices 120 is being used can be maintained in the data lake 124 in association with the first identifier assigned to the account associated with the wireless communications service. The information about how a specific one of the mobile communications devices 120 associated with the household 108 is being used can further be associated with the identification that uniquely identifies the specific mobile communications device 120.

The devices can additionally include an Internet-capable device 114, such as a PC, a laptop, a portable device, or another suitable device that can send and receive data packets via the network 104 according to an Internet service provided by the service provider 117 and subscribed to by the user 119. It should be understood that the household 108 can be associated with more than one Internet-capable devices 114. According to embodiments, the identity management system 126 associated with the service provider 117 collects information about how the Internet-capable device 114 is being used, such as Domain Name System (“DNS”) information associated with resources connected to using the Internet-capable device 114. The information collected about how the Internet-capable device 114 is being used can be associated with the first identifier assigned to the account established for the user 119/household 108 based on the user 119 subscribing to the Internet service provided by the service provider 117. The information collected about how the Internet-capable device 114 is being used can be maintained in the data lake 124 in association with the first identifier assigned to the account associated with the Internet service.

FIG. 1 also shows that the identity management system 126 can be in communication with a data management platform (DMP) 128 and an advertisement delivery system 130 via the network 104. As discussed further below with reference to FIG. 2, the data collected by the identity management system 126 (i.e., first-party data) and associated with a particular first identifier or first identifiers can be processed to deduce traits and attributes of the user 119, household 108 and/or users related to the household. The identity management system 126 can provide information about these traits and attributes to the DMP 128. As discussed further herein, the DMP 128 can use the trait and attribute information deduced from first-party data collected by the identity management system 126 to identify audiences to which targeted information should be delivered. The DMP 128 can identify the audiences to the advertisement delivery system 130 for publication of the targeted information to the corresponding users of the audience. Although the operating environment 100 illustrated in FIG. 1 shows one household, one advertisement delivery system, one service provider, one identity management system, one data lake, one DMP and one network, it should be understood that various implementations of the operating environment 100 can include one or more of each of the household 108, the advertisement delivery system 130, the service provider 117, the identity management system 126, the data lake 124, the DMP 128 and the network 104. As such, the illustrated embodiment should be understood as being illustrative, and should not be construed as being limiting in any way.

Turning now to FIG. 2, aspects of the first-party data collected by the identity management system 126 are shown. According to embodiments, the first-party data collected by the identity management system 126 is associated with a respective first identifier, such as first identifiers 212A-212D, assigned to an account associated with an account holder, such as the user 119, and/or a household of the account holder, such as the household 108, by a service provider, such as the service provider 117.

Considering an example where the service provider 117 provides a television service, a telephone service, a mobile telephone service, and an Internet service, records 202A-202D have been generated based on, for example, the user 119 subscribing to these services provided by the service provider 117. For example, the first identifier 212A can be assigned to a television service account of the user 119/household 108 of the user 119 in response to the user 119 subscribing to the television service provided by the service provider 117. The user 119 can provide PII to the service provider 117, which can be associated with the first identifier 212A to generate the record 202A.

As the user 119 and/or other members of the household 108 associated with the user 119 utilize a receiver device, such as the receiver device 110, to receive the television service provided by the service provider 117, first-party data, such as viewership data, can be collected, associated with the first identifier 212A, and included in the record 202A. The record 202A can be maintained in a data repository, such as the data lake 124, and updated as new first-user data associated with the television service is obtained from the user 119/household 108. According to embodiments, other information about the user 119/household 108 obtained by the service provider 117, such as third-party consumer data purchased from third-party providers, can also be associated with the first identifier 212A and included in the record 202A or associated with the first identifier 212A and maintained separately in the data lake 124. The identity management system 126 can access all of the data associated with the first identifier 212A and process the data to deduce traits and attributes about the user 119/household 108 that relate to the use of the television service provided by the service provider 117. The identity management system 126 can associate these traits and attributes with the first identifier 212A to generate a file 204A.

Similarly, the first identifier 212B can be assigned to a telephone service account of the user 119/household 108 of the user 119 in response to the user 119 subscribing to the telephone service provided by the service provider 117. The user 119 can provide PII to the service provider 117, which can be associated with the first identifier 212B to generate the record 202B. As the user 119 and/or other members of the household 108 associated with the user 119 utilize a communications device, such as the communications device 116, to receive the telephone service provided by the service provider 117, first-party data, such as information about how the communications device 116 is being used, can be collected, associated with the first identifier 212B, and included in the record 202B. The record 202B can be maintained in the data lake 124 and updated as new first-user data is obtained from the user 119/household 108. According to embodiments, other information about the user 119/household 108 obtained by the service provider 117, such as third-party consumer data purchased from third-party providers, can also be associated with the first identifier 212B and included in the record 202B or associated with the first identifier 212B and maintained separately in the data lake 124. The identity management system 126 can access all of the data associated with the first identifier 212B and process the data to deduce traits and attributes about the user 119/household 108 that relate to the use of the telephone service provided by the service provider 117. The identity management system 126 can associate these traits and attributes with the first identifier 212B to generate a file 204B.

The first identifier 212C can be assigned to a mobile telephone service account of the user 119/household 108 of the user 119 in response to the user 119 subscribing to the mobile telephone service provided by the service provider 117. The user 119 can provide PII to the service provider 117, which can be associated with the first identifier 212C to generate the record 202C. As the user 119 and/or other members of the household 108 associated with the user 119 utilize one or more mobile communications devices, such as the mobile communications device 120, to receive the mobile telephone service provided by the service provider 117, first-party data, such as information about how the mobile communications device 120 is being used, can be collected, associated with the first identifier 212C, and included in the record 202C. The record 202C can be maintained in the data lake 124 and updated as new first-user data is obtained from the user 119/household 108. According to embodiments, other information about the user 119/household 108 obtained by the service provider 117, such as third-party consumer data purchased from third-party providers, can also be associated with the first identifier 212C and included in the record 202C or associated with the first identifier 212C and maintained separately in the data lake 124. The identity management system 126 can access all of the data associated with the first identifier 212C and process the data to deduce traits and attributes about the user 119/household 108 that relate to the use of the mobile telephone service provided by the service provider 117. The identity management system 126 can associate these traits and attributes with the first identifier 212C to generate a file 204C.

In addition, the first identifier 212D can be assigned to an Internet service account of the user 119/household 108 of the user 119 in response to the user 119 subscribing to the Internet service provided by the service provider 117. The user 119 can provide PII to the service provider 117, which can be associated with the first identifier 212D to generate the record 202D. As the user 119 and/or other members of the household 108 associated with the user 119 utilize one or more Internet-capable devices, such as the Internet-capable device 114, to receive the Internet service provided by the service provider 117, first-party data, such as information about how the Internet-capable device 114 is being used, can be collected, associated with the first identifier 212D, and included in the record 202D. The record 202D can be maintained in the data lake 124 and updated as new first-user data is obtained from the user 119/household 108. According to embodiments, other information about the user 119/household 108 obtained by the service provider 117, such as third-party consumer data purchased from third-party providers, can also be associated with the first identifier 212D and included in the record 202D or associated with the first identifier 212D and maintained separately in the data lake 124. The identity management system 126 can access all of the data associated with the first identifier 212D and process the data to deduce traits and attributes about the user 119/household 108 that relate to the use of the Internet service provided by the service provider 117. The identity management system 126 can associate these traits and attributes with the first identifier 212D to generate a file 204D.

In the example provided above, each of the accounts established for the user 119/household 108 of the user 119 is assigned a different first identifier. According to this embodiment, the first identifiers 212A, 212B, 212C, and 212D represent four different first identifiers. According to further embodiments, each account established for the same user/household, such as the user 119/household 108, is assigned the same first identifier. In this example, the first identifiers 212A, 212B, 212C, and 212D represent the same first identifier. According to further embodiments, each account established for the same user/household, such as the user 119/household 108, is assigned a unique identifier (not shown), but all of the accounts for the same user/household is, in addition to the unique identifier, assigned the same first identifier. In this example, the first identifiers 212A, 212B, 212C, and 212D represent the same first identifier.

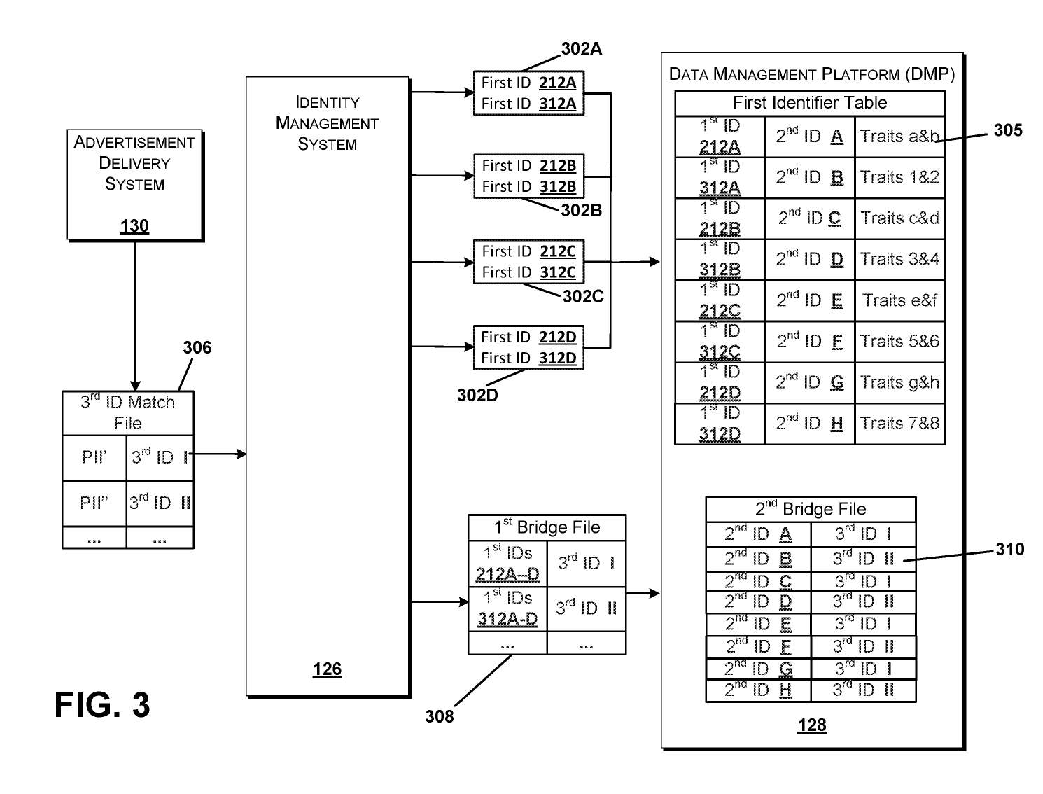

Referring now to FIG. 3, as schematically shown, the identity management system 126 provides to the DM′ 128 one or more first identifier files 302A-302E including first identifiers, such as the first identifiers 212A-D and first identifiers 312A-D, assigned to the customers of the service provider 117. The first identifier files 302A-302D that are sent to the DM′ 128 can be created by the identity management system 126 according to the type of service account to which each first identifier is assigned. For instance, first identifiers, such as the first identifiers 212A and 312A, associated with television service accounts of the service provider 117 can be included together in a first identifier file, such as the first identifier file 302A; first identifiers, such as the first identifiers 212B and 312B, associated with telephone service accounts of the service provider 117 can be included together in a first identifier file, such as the first identifier file 302B; first identifiers, such as the first identifiers 212C and 312C, associated with mobile telephone service accounts of the service provider 117 can be included together in a first identifier file, such as the first identifier file 302C; and first identifiers, such as the first identifiers 212D and 312D, associated with Internet service accounts of the service provider 117 can be included together in a first identifier file, such as the first identifier file 302D. Alternatively, all of the first identifiers assigned to customers of the service provider can be provided to the DMP 128 in one first identifier file or in multiple first identifier files grouped according to associations other than by account type.

The DMP 128 assigns a second identifier, such as second identifiers A-H, to each of the first identifiers 212A-D and 312A-D received from the identity management system 126. According to embodiments, the DMP 128 assigns a second identifier to each different first identifier received from the identity management system 126. Thus, if the identity management system 126 assigns a different first identifier to each account established for the user 119/household 108, then the DMP can assign a different second identifier to each of the first identifiers associated with the user 119/household 108. If, on the other hand, the identity management system 126 assigns the same first identifier to each account established for the user 119/household 108, then the DMP can assign the same second identifier to the first identifier associated with the user 119/household 108. The identity management system 126 can load the trait and attribute data, such as traits a-h and 1-6, associated with the first identifiers 212A-D and 312A-D, respectively, to the DMP 128. According to embodiments, the DMP 128 associates the trait and attribute data received from the identity management system 126 with the second identifier assigned to the first identifier for which the trait and attribute data corresponds. The DMP 128 can generate a first identifier table 305 to set forth the associations between the first identifiers, the respective trait and attribute data for each of the first identifiers, and the second identifiers assigned to each first identifier. Thus, all of the trait and attribute data collected by the identity management system 126 can be loaded to the DMP 128 and stored.

As illustrated in FIG. 3, the identity management system 126 can receive one or more third identifier match files, such as the third identifier match file 306, from the advertisement delivery system 130. The third identifier match file 306 can include PII collected by the advertisement delivery system 130 and third identifiers assigned by the advertisement delivery system 130 to the PII. For instance, as illustrated in FIG. 3, the third identifier match file 306 includes PIT′ and corresponding third identifier I assigned to the PIT′ by the advertisement delivery system 130 and PII″ and corresponding third identifier II assigned to the PII″ by the advertisement delivery system 130. According to embodiments, the identity management system 126 uses the third identifier match file 306 to try and match PII collected by the advertisement delivery system 130 with PII collected by the identity management system 126 in order to determine the third identifiers provided by the advertisement delivery system 130 that represent the same users/households as the first identifiers.

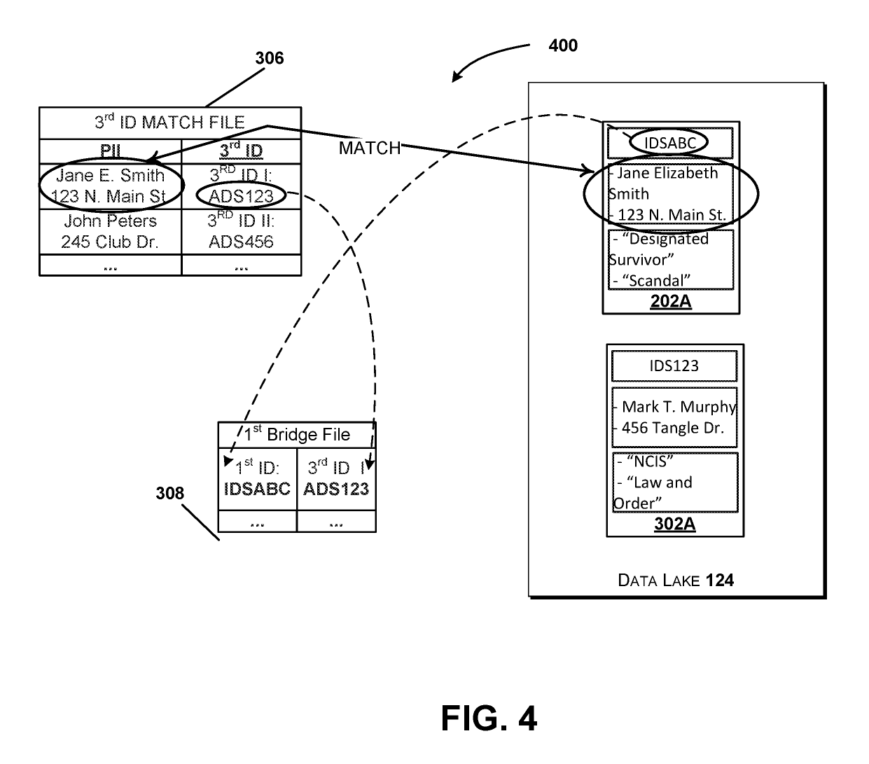

For example, referring to FIG. 4, aspects of an example mapping or pairing process 400 are shown according to concepts and technologies disclosed herein. As illustrated by the example mapping process 400, the identity management system 126 can determine that the PII “Jane E. Smith, 123 N. Main St.” (i.e., PIT′) of the third identifier match file 306 has some commonalities with the PII “Jane Elizabeth Smith, 123 North Main Street” of the record 202A generated by the identity management system 126. Based on these commonalities, the identity management system 126 can determine that the PII′ provided by the advertisement delivery system 130 and the PII of the record 202A collected by the identity management system 126 correspond to the same user/account/household. Accordingly, the identity management system 126 can map or pair the third identifier ADS123 (i.e., third identifier I) assigned by the advertisement delivery system 130 with the first identifier IDSABC (i.e., first identifier 212A) assigned by the identity management system 126. Based on mapping this pair of first and third identifiers and other pairs of first and third identifiers that also have commonalities in the PII, the identity management system 126 can generate the first bridge file 308 shown in FIGS. 3 and 4 to set forth the associations between the first identifiers of the identity management system 126 and the third identifiers of the advertisement delivery system 130. The identity management system 126 can provide the first bridge file 308 to the DMP 128.

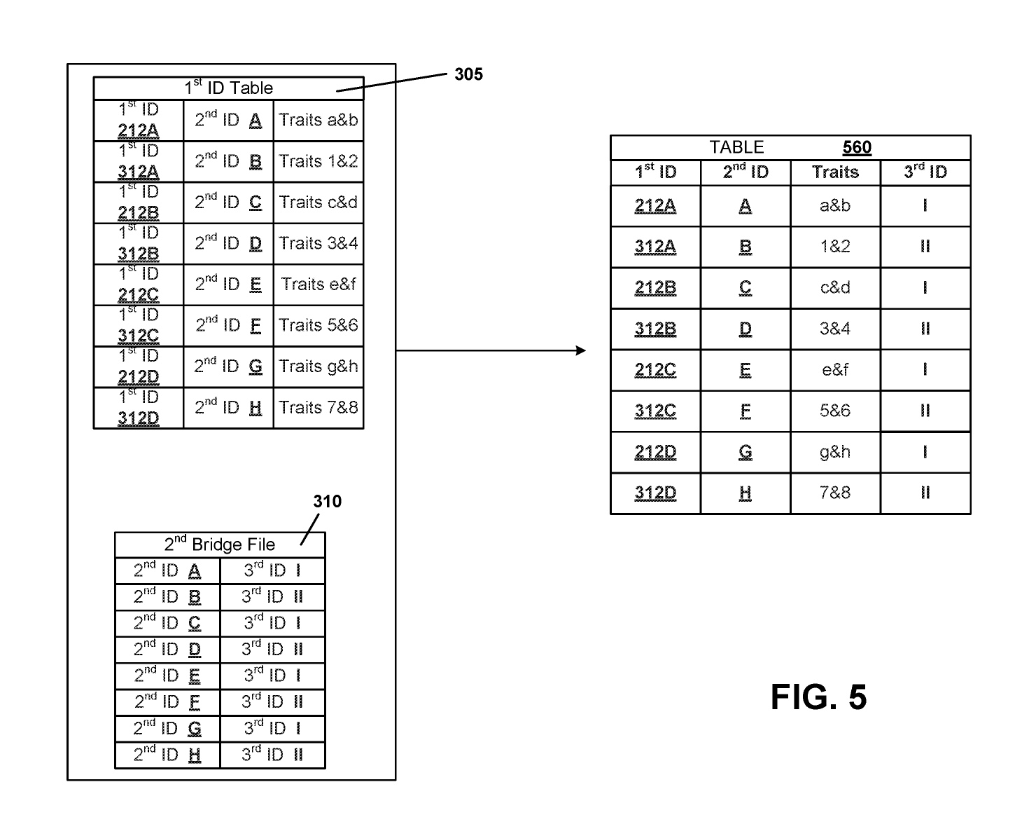

The DMP 128 can use the first identifier table 305 and the first bridge file 308 received from the identity management system 126 to match each third identifier listed in the first bridge file 308 with the respective second identifier assigned by the DMP 128 based on the first identifier. Because the first bridge file 308 received from the identity management system 126 associates each first identifier with a corresponding third identifier from the advertisement delivery system 130, then the DMP 128 can determine, based on the first identifier, which third identifiers and second identifiers represent the same user/account/household. The DMP 128 can generate a second bridge file 310 to set forth the associations between the second identifiers of the DMP 128 and the third identifiers of the advertisement delivery system 130. The DMP 128 can use the first identifier table 305 and the second bridge file 310 to create a master table 560, as shown in FIG. 5, to correlate corresponding first, second and third identifiers along with respective trait data.

In some embodiments, the DMP 128 can use the information loaded to the DMP 128, such as the trait and attribute data from the identity management system 126, to determine an audience for receiving targeted information. For example, for targeted information directed to males from the age of 18-30 who enjoy watching comedies, the DMP 128 can identify the second identifiers that represent users/households having matching trait and/or attribute data maintained by the DMP 128. The DMP 128 can create an audience of those second identifiers, which can include a list of the second identifiers that correspond with each audience member. Using the second bridge file 310 and/or master table 560, the DMP 128 can identify the third identifiers recognized by the advertisement delivery system 130 that correlate with the second identifiers of the selected audience. The DMP 128 can then provide these third identifiers to the advertisement delivery system 130 with instructions to publish the targeted information. Since the third identifiers are native to the advertisement delivery system 130, the advertisement delivery system 130 recognizes the third identifiers identified by the DMP 128 and is able to determine where to publish the targeted information based on the respective PII associated with each of the third identifiers.

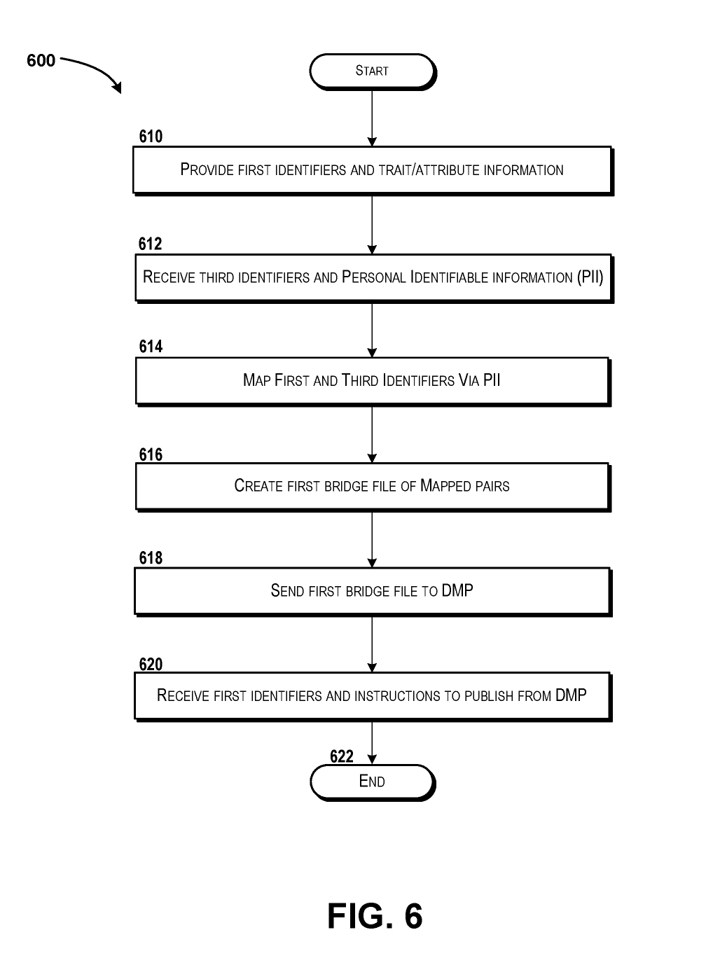

Turning now to FIG. 6, aspects of a method 600 for managing first-party identification information will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the identity management system 126, to perform one or more operations and/or causing the processor to direct other components of the computing system or device to perform one or more of the operations.

For purposes of illustrating and describing the concepts of the present disclosure, the method 600 is described herein as being performed by the identity management system 126 via execution of one or more software modules such as, for example, the identity manager application 830 shown in FIG. 8. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 600 begins at operation 610. At operation 610, the identity management system 126 provides first identifiers, such as the first identifiers 212A-D, associated with a service provider, such as the service provider 117, and respective trait data, such as the trait data a-h, to a DMP, such as the DMP 128. Although the operation 610 describes both the first identifiers and corresponding trait data being provided to the DMP simultaneously, in some embodiments, the first identifiers are provided to the DMP 128 via first identifier files, such as the first identifier files 302A-302D, and then the corresponding trait data is provided to the DMP 128 once the DMP 128 has assigned second identifiers to at least some of the first identifiers of the first identifier files 302A-302D. The respective trait data provided by the identity management system 126 can be information deduced by the identity management system 126 from first-party data collected from user(s)/subscriber(s) associated with the service provider 117 and/or third-party consumer data about the users/subscribers of the service provider 117 attained by the service provider 117. The first-party data and/or third-party consumer data for a user/household can be associated with a first identifier, such as the first identifier 212A, assigned to the user/household and can be included in a record, such as the record 202A. The identity management system 126 can access the first-party data and/or third-party consumer data from a data repository, such as the data lake 124, which can be used to store the records, such as the record 202A.

The DMP 128 assigns a second identifier to each of the first identifiers received from the identity management system 126. According to embodiments, the DMP 128 assigns a second identifier to each different first identifier received from the identity management system 126. Thus, if the identity management system 126 assigns a different first identifier to each account established for a particular user/household of the user, such as the user 119/household 108, then the DMP can assign a different second identifier to each of the first identifiers associated with the user 119/household 108. If, on the other hand, the identity management system 126 assigns the same first identifier to each account established for a particular user/household, such as the user 119/household 108, then the DMP can assign the same second identifier to the first identifier associated with the user 119/household 108. According to embodiments, the DMP 128 associates the trait data received from the identity management system 126 with the second identifier assigned to the first identifier for which the trait data corresponds. The DMP 128 can generate a first identifier table, such as the first identifier table 305, to set forth the associations between the first identifiers, the respective trait data for each of the first identifiers, and the second identifiers assigned to each first identifier by the DMP 128.

From operation 610, the method 600 can proceed to operation 612. At operation 612, the identity management system 126 receives PII, such as PIP and PII″, and corresponding third identifiers assigned to the PII, such as third identifiers I and II, respectively, from an advertisement delivery system, such as the advertisement delivery system 130. According to embodiments, the PII and the assigned third identifiers are included in a third identifier match file, such as the third identifier match file 306, provided by the advertisement delivery system 130. In some embodiments, the third identifier match file 306 can be automatically received by the identity management system 126 from the advertisement delivery system 130, such as being pushed to the identity management system 126 periodically from the advertisement delivery system 130. For example, the PII and corresponding third identifiers can be pushed to the identity management system 126 weekly, bi-monthly, monthly, or at any other interval. In other embodiments, the identity management system 126 can, as needed, request that the advertisement delivery system 130 provide the PII and assigned third identifiers. Since new users/subscribers can be continuously established by the service provider 107, the identity management system 126 can use the PII and corresponding third identifiers periodically received from the advertisement delivery system 130 to try and match with the newly established users/subscribers.

From operation 612, the method 600 can proceed to operation 614. At operation 614, the identity management system 126 can map the first identifiers assigned by the identity management system 126, such as the first identifiers 212A-212D, to the third identifiers provided by the advertisement delivery system 130, such as the third identifiers I and II, based on commonalities determined between the PII corresponding to each of the first identifiers 212A-212D and the PII provided by the advertisement delivery system 130 to create one or more first identifier and third identifier pairs. Considering the example mapping process 400 of FIG. 4, the identity management system 126 can determine that the PII “Jane E. Smith, 123 N. Main St.” (i.e., PIT′) of the third identifier match file 306 has some commonalities with the PII “Jane Elizabeth Smith, 123 North Main Street” of the record 202A generated by the identity management system 126. Based on these commonalities, the identity management system 126 can determine that the PIT′ provided by the advertisement delivery system 130 and the PII of the record 202A collected by the identity management system 126 correspond to the same user/account/household. Accordingly, the identity management system 126 can map or pair the third identifier ADS123 (i.e., third identifier I) assigned by the advertisement delivery system 130 with the first identifier IDSABC (i.e., first identifier 212A) assigned by the identity management system 126.

From operation 614, the method 600 proceeds to operation 616, where the identity management system 126 can create an anonymous first bridge file, such as the first bridge file 308, including the first identifier and third identifier pairs generated in operation 614. The bridge file 308 can include the first identifiers of the identity management system 126 and the corresponding third identifiers from the advertisement delivery system 130 mapped to each of the first identifiers based on commonalities determined in the PII collected by the identity management system 126 and the PII provided by the advertisement delivery system 130. Since the bridge file 308 lacks any PII data, the first bridge file 308 is considered anonymous.

From operation 616, the method 600 proceeds to operation 618, where the identity management system 126 can send the anonymous bridge file 308 to the DMP 128. The DMP 128 can use the first identifier table 305 and the first bridge file 308 received from the identity management system 126 to match, using the first identifier, each third identifier listed in the first bridge file 308 with the respective second identifier assigned by the DMP 128. Because the first bridge file 308 received from the identity management system 126 associates each first identifier with a corresponding third identifier from the advertisement delivery system 130, then the DMP 128 can determine, based on the first identifier, which third identifiers and second identifiers represent the same user/account/household. The DMP 128 can generate a second bridge file, such as the second bridge file 310, to set forth the associations between the second identifiers of the DMP 128 and the third identifiers of the advertisement delivery system 130. The DMP 128 can use the first identifier table 305 and the second bridge file 310 to create a master table, such as the master table 560 shown in FIG. 5, to correlate corresponding first, second and third identifiers along with respective trait data. Using the first identifier table 305 and the second bridge file 310 and/or the master table 560, the DMP 128 can perform fast, efficient and anonymous searches for audiences associated with trait data that matches criteria associated with targeted information. For example, for targeted information directed to males from the age of 18-30 who enjoy watching comedies, the DMP 128 can identify the second identifiers that represent users/households having matching trait and/or attribute data maintained by the DMP 128. The DMP 128 can return the results of the search for the audience as a list of second identifiers assigned and recognized by the DMP 128 that correspond with the trait data determined to match the criteria of the targeted information. Using the second bridge file 310 and/or master table 560, the DMP 128 can identify the third identifiers recognized by the advertisement delivery system 130 that correlate with the second identifiers of the selected audience. The DMP 128 can then provide these third identifiers to the advertisement delivery system 130 with instructions to publish the targeted information. Since the third identifiers are native to the advertisement delivery system 130, the advertisement delivery system 130 recognizes the third identifiers identified by the DMP 128 and is able to determine where to publish the targeted information based on the respective PII associated with each of the third identifiers.

In some embodiments, the DMP 128 can determine that the service provider 117 will act as its own advertisement delivery system to publish targeted information to one or more members of the audience identified by the DMP 128 to receive the targeted information. According to these embodiments, the DMP 128 can use the first identifier table 305 to determine the one or more first identifiers that correspond to the one or more second identifiers of these members of the audience. The DMP 128 can then send the corresponding one or more first identifiers to the identity management system 126 with instructions to publish the targeted information. Thus, from operation 618, the method 600 can proceed to operation 620, where the identity management system 126 can receive the one or more first identifiers from the DMP 128 with instructions to publish the targeted information. The identity management system 126 can determine the users/households associated with the first identifiers based on PII managed by the identity management system 126 that is associated with the first identifiers. For example, the identity management system 126 can access the records 202A-202D associated with the first identifiers received from the DMP 128 to determine PII corresponding to each of the first identifiers. According to embodiments, the PII can include identification information regarding the users/households associated with the first identifiers as well as contact information for the users/households that can be used to determine how to publish the targeted information to the users/households. From operation 620, the method 600 proceeds to operation 622, where the method 600 ends.

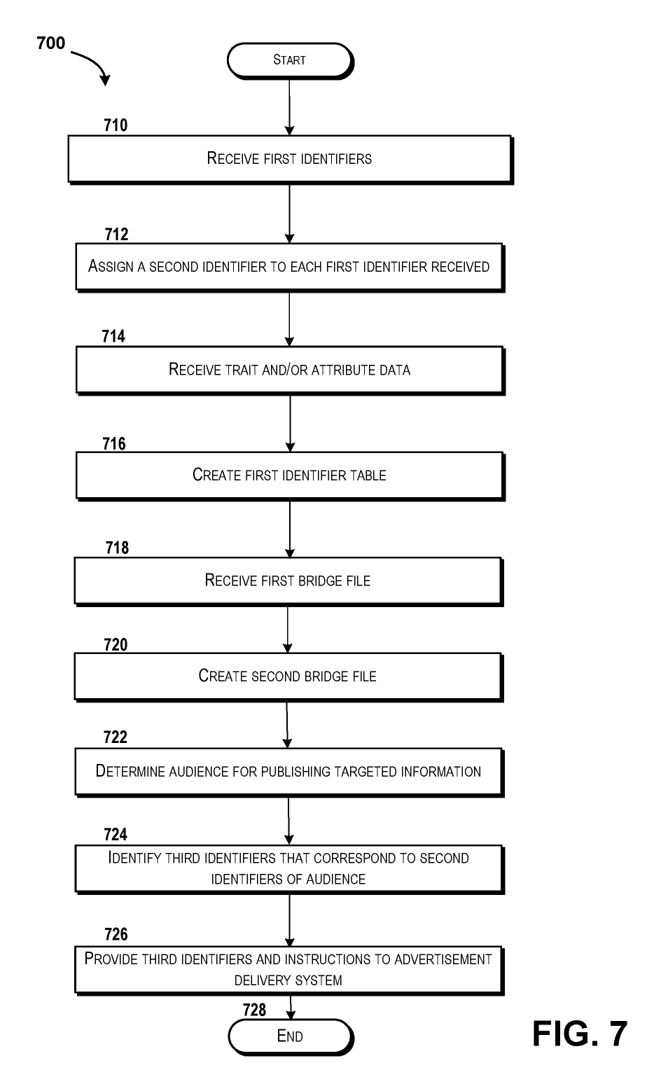

Turning now to FIG. 7, aspects of a method 700 for determining targeted information search results will be described in detail, according to an illustrative embodiment. For purposes of illustrating and describing the concepts of the present disclosure, the method 700 is described herein as being performed by the DMP 128 via execution of one or more software modules. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 700 begins at operation 710. At operation 710, the DMP 128 receives first identifiers, such as the first identifiers 212A-D and 312A-D from the identity management system 126. According to embodiments, the identity management system 126 provides to the DMP 128 one or more first identifier files, such as the first identifier files 302A-302E illustrated in FIG. 3, including the first identifiers 212A-D and 312A-D assigned to the customers of the service provider 117. The first identifier files 302A-302D that are sent to the DMP 128 can be created by the identity management system 126 according to the type of service account to which each first identifier is assigned. For instance, first identifiers, such as the first identifiers 212A and 312A, associated with television service accounts of the service provider 117 can be included together in a first identifier file, such as the first identifier file 302A; first identifiers, such as the first identifiers 212B and 312B, associated with telephone service accounts of the service provider 117 can be included together in a first identifier file, such as the first identifier file 302B; first identifiers, such as the first identifiers 212C and 312C, associated with mobile telephone service accounts of the service provider 117 can be included together in a first identifier file, such as the first identifier file 302C; and first identifiers, such as the first identifiers 212D and 312D, associated with Internet service accounts of the service provider 117 can be included together in a first identifier file, such as the first identifier file 302D. Alternatively, all of the first identifiers assigned to customers of the service provider 117 can be provided to the DMP 128 in one first identifier file or in multiple first identifier files grouped according to associations other than by account type.

From operation 710, the method 700 proceeds to operation 720, where the DMP 128 assigns a second identifier, such as second identifiers A-H illustrated in FIG. 3, to each of the first identifiers 212A-D and 312A-D received from the identity management system 126. According to embodiments, the DMP 128 assigns a second identifier to each different first identifier received from the identity management system 126. Thus, if the identity management system 126 assigns a different first identifier to each account established for a user/household, such as the user 119/household 108 illustrated in FIG. 1, then the DMP can assign a different second identifier to each of the first identifiers associated with the user 119/household 108. If, on the other hand, the identity management system 126 assigns the same first identifier to each account established for the user 119/household 108, then the DMP 128 can assign the same second identifier to the first identifier associated with the user 119/household 108.

From operation 712, the method 700 proceeds to operation 714, where the DMP 128 receives trait and/or attribute data associated with the first identifiers 212A-D and 312A-D, such as traits a-h and 1-6 illustrated in FIG. 3, from the identity management system 126. From operation 714, the method 700 proceeds to operation 716, wherein the DMP 128 can associate the trait and/or attribute data received from the identity management system 126 with the second identifiers A-H assigned to the first identifiers 212A-D and 312A-D for which the trait and attribute data correspond. According to some embodiments, the operations 710 and 714 can be combined such that the DMP 128 receives the first identifiers 212A-D and 312A-D and corresponding trait and attribute data together from the identity management system 126. The DMP 128 can then assign a second identifier to each first identifier and corresponding trait and attribute data, similar to the operation 712.

From operation 714, the method 700 proceeds to operation 716, where the DMP 128 can generate a first identifier table, such as the first identifier table 305, to set forth the associations between the first identifiers 212A-D and 312A-D, the respective trait and attribute data for each of the first identifiers 212A-D and 312A-D, and the second identifiers A-H assigned to each first identifier. Although FIG. 7 illustrates the creation of the first identifier table 305 occurring after receipt of the trait and/or attribute data from the identity management system 126, the DMP 128 can create the first identifier table 305 after assigning a second identifier to each first identifier received from the identity management system 126, but before the identity management system 126 has loaded the trait and/or attribute data corresponding to the first identifiers to the DMP 128. Once the trait and/or attribute data is received by the DMP 128, the trait and/or attribute data can be added to the first identifier table 305 based on the respective first identifier to which the trait and/or attribute data corresponds.

From operation 716, the method 700 proceeds to operation 718, where the DMP 128 can receive a first bridge file, such as the first bridge file 308 illustrated in FIG. 3, from the identity management system 126. According to embodiments, the first bridge file 308 includes the first identifiers 212A-D and 312A-D paired to third identifiers, such as the third identifiers I and II illustrated in FIG. 3, provided by an advertisement delivery system, such as the advertisement deliver system 130 that have been determined by the identity management system 126 to correspond to the first identifiers 212A-D and 312A-D.

From operation 718, the method 700 can proceed to operation 720, where the DMP 128 can generate a second bridge file, such as the second bridge file 310. According to embodiments, the DMP 128 uses the associations set forth in the first identifier table 305 and the associations set forth in the first bridge file 308 to match, using each first identifier as the key, each third identifier listed in the first bridge file 308 with the respective second identifier assigned by the DMP 128. Because the first bridge file 308 received from the identity management system 126 associates each first identifier with a corresponding third identifier from the advertisement delivery system 130, then the DMP 128 can determine, based on each first identifier, which third identifiers and second identifiers represent the same user/account/household. The DMP 128 can generate the second bridge file 310 to set forth the associations between the second identifiers of the DMP 128 and the third identifiers of the advertisement delivery system 130. The DMP 128 can use the first identifier table 305 and the second bridge file 310 to create a master table, such as the master table 560 as shown in FIG. 5, to correlate corresponding first, second and third identifiers along with respective trait data.

From operation 720, the method 700 can proceed to operation 722, where the DMP 128 can use the information loaded to the DMP 128, such as the trait and attribute data from the identity management system 126, to determine an audience for receiving targeted information. For example, for targeted information directed to males from the age of 18-30 who enjoy watching comedies, the DMP 128 can identify the second identifiers that represent users/households having trait and/or attribute data that match the traits of male, ages 18-30, and comedy television genre. The DMP 128 can create an audience of those second identifiers, which can include a list of the second identifiers that correspond with each audience member.

From operation 722, the method 700 proceeds to operation 724, where the DMP 128 can use the second bridge file 310 and/or master table 560 to identify the third identifiers recognized by the advertisement delivery system 130 that correlate with the second identifiers of the selected audience. From operation 724, the method 700 proceeds to operation 726, where the DMP 128 can then provide these third identifiers to the advertisement delivery system 130 with instructions to publish the targeted information. Since the third identifiers are native to the advertisement delivery system 130, the advertisement delivery system 130 recognizes the third identifiers identified by the DMP 128 and is able to determine where to publish the targeted information based on the respective PII associated with each of the third identifiers. From operation 726, the method 700 proceeds to operation 728, where the method 700 ends.

FIG. 8 is a block diagram illustrating a computer system 800 configured to perform various operations described herein for managing first-party data, in accordance with various embodiments of the concepts and technologies disclosed herein. The computer system 800 includes a processing unit 802, a memory 804, one or more user interface devices 806, one or more input/output (“I/O”) devices 808, and one or more network devices 810, each of which is operatively connected to a system bus 812. The bus 812 enables bi-directional communication between the processing unit 802, the memory 804, the user interface devices 806, the I/O devices 808, and the network devices 810. In some embodiments, the identity management system 126, the DMP 128, the advertisement delivery system 130, one or more components of the network 104, or some combination thereof is/are configured, at least in part, like the computer system 800.

The processing unit 802 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 804 communicates with the processing unit 802 via the system bus 812. In some embodiments, the memory 804 is operatively connected to a memory controller (not shown) that enables communication with the processing unit 802 via the system bus 812. The memory 804 includes an operating system 814 and one or more program modules 816. The operating system 814 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 816 may include various software and/or program modules described herein. In some embodiments, for example, the program modules 816 include the identity manager application 830. This and/or other programs can be embodied in computer-readable media containing instructions that, when executed by the processing unit 802, perform one or more of the methods 600, 700 described in detail above with respect to FIGS. 6-7 and/or other functionality as illustrated and described herein. It can be appreciated that, at least by virtue of the instructions embodying the methods 600, 700, and/or other functionality illustrated and described herein being stored in the memory 804 and/or accessed and/or executed by the processing unit 802, the computer system 800 is a special-purpose computing system that can facilitate providing the functionality illustrated and described herein. According to embodiments, the program modules 816 may be embodied in hardware, software, firmware, or any combination thereof. Although not shown in FIG. 8, it should be understood that the memory 804 also can be configured to store the trait data 834 and/or other data, if desired, such as PII 835.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer-readable storage medium” and variations thereof does not include waves or signals per se and/or communication media.

The user interface devices 806 may include one or more devices with which a user accesses the computer system 800. The user interface devices 806 may include, but are not limited to, computers, servers, personal digital assistants, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer.

The network devices 810 enable the computer system 800 to communicate with other networks or remote systems via a network, such as the network 104. Examples of the network devices 810 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 9, additional details of the network 104 are illustrated, according to an illustrative embodiment. The network 104 can include a cellular network 902; a packet data network 904, for example, the Internet; a circuit switched network 906, for example, a publicly switched telephone network (“PSTN”); and a content delivery network 908, for example a television delivery network such as a satellite or cable network, or the like. In the specification, the network 104 is used to refer broadly to any combination of the networks 902, 904, 906 and 908. It should be appreciated that substantially all of the functionality described with reference to the network 104 can be performed by the cellular network 902, the packet data network 904, the circuit switched network 906, and/or the content delivery network 908, alone or in combination with other networks, network elements, and the like.

The cellular network 902 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 902 also includes radios and nodes for receiving and transmitting voice, data, and combinations thereof to and from radio transceivers, networks, the packet data network 904, and the circuit switched network 906.

A mobile communications device, such as the mobile communications device 120 of FIG. 1, can include, for example, a cellular telephone, a user equipment, a mobile terminal, a PDA, a laptop computer, a handheld computer, and combinations thereof, that can be operatively connected to the cellular network 902. The cellular network 902 can be configured as a 2G GSM network and can provide data communications via GPRS and/or EDGE. Additionally, or alternatively, the cellular network 902 can be configured as a 3G UMTS network and can provide data communications via the HSPA protocol family, for example, HSDPA, EUL (also referred to as HSUPA), and HSPA+. The cellular network 902 also is compatible with 4G mobile communications standards as well as evolved and future mobile standards.

The packet data network 904 includes various devices, for example, servers, computers, databases, and other devices in communication with another, as is generally known. The devices of the packet data network 904 are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 904 includes or is in communication with the Internet.

The circuit switched network 906 includes various hardware and software for providing circuit switched communications. The circuit switched network 906 may include, or may be, what is often referred to as a plain old telephone system (POTS). The functionality of a circuit switched network 906 or other circuit-switched network are generally known and will not be described herein in detail.

The illustrated cellular network 902 is shown in communication with the packet data network 904, the circuit switched network 906 and the content delivery network 908, though it should be appreciated that this is not necessarily the case. One or more Internet-capable devices, such as the Internet-capable device 114 of FIG. 1, can include, for example, a PC, a laptop, a portable device, or another suitable device, that can communicate with one or more cellular networks 902, and devices connected thereto, through the packet data network 904. It also should be appreciated that the Internet-capable device 114 can communicate with the packet data network 904 through the circuit switched network 906, the cellular network 902, and/or via other networks (not illustrated).

A communications device, such as the communications device 116 of FIG. 1, can include, for example, a telephone, facsimile machine, modem, computer, or the like, that can be in communication with the circuit switched network 906, and therethrough to the packet data network 904 and/or the cellular network 902. It should be appreciated that the communications device 116 can be an Internet-capable device, and can be substantially similar to the Internet-capable device 114.

The content delivery network 908 includes various software and devices, for example, servers, computers, satellites, databases and other devices in communication with one another for providing content, such as television content, to receiver devices, such as the receiver device 110 of FIG. 1. The receiver device 110 can include, for example, a satellite television receiver, a set-top box device, digital video recorder or combinations thereof that can be operatively connected to the content delivery network 908. It should be appreciated that the receiver device 110 can be an Internet-capable device.

Based on the foregoing, it should be appreciated that systems and methods for managing offline first-party identity information and performing targeted advertising searches have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
providing, by an identity management system, to a data management platform, a plurality of first identifiers and respective trait data associated with each of the plurality of first identifiers, wherein each of the plurality of first identifiers is associated with a respective account of a plurality of accounts managed by the identity management system, wherein the respective trait data associated with a first identifier of the plurality of first identifiers corresponds to a user associated with the respective account associated with the first identifier, and wherein a respective second identifier is assigned by the data management platform to each of the plurality of first identifiers;
receiving, by the identity management system, from an advertisement delivery system, a plurality of third identifiers and corresponding first personal identifiable information associated with each of the plurality of third identifiers;
mapping, by the identity management system, based on commonalities determined between the first personal identifiable information from the advertisement delivery system and second personal identifiable information associated with each of the plurality of accounts managed by the identity management system, each of the plurality of first identifiers with a respective one of the plurality of third identifiers to create a plurality of first identifier and third identifier pairs; and
providing, by the identity management system, to the data management platform, the plurality of first identifier and third identifier pairs for use in creating a second bridge file comprising each corresponding second identifier paired to a respective one of the plurality of third identifiers according to the plurality of first identifiers.

2. The method of claim 1, wherein providing the plurality of first identifiers to the data management platform comprises providing a file comprising at least a portion of the plurality of first identifiers to the data management platform.

3. The method of claim 2, wherein the at least the portion of the plurality of first identifiers of the file is associated with a same type of account of the plurality of accounts.

4. The method of claim 1, further comprising creating, by the identity management system, a first bridge file comprising each of the plurality of first identifier and third identifier pairs.

5. The method of claim 4, wherein providing the plurality of first identifier and third identifier pairs to the data management platform comprises providing the first bridge file to the data management platform.

6. The method of claim 1, further comprising:
collecting first-party data from a plurality of users associated with the plurality of accounts managed by the identity management system; and
deducing, based at least in party on the first-party data, the respective trait data associated with each of the plurality of users.

7. The method of claim 1, wherein the data management platform determines, based at least in part on the respective trait data associated with each of the plurality of first identifiers, an audience to receive targeted information, wherein the data management platform uses the second bridge file to determine a respective third identifier for at least a portion of members of the audience, and wherein the data management platform provides the respective third identifier for each of the portion of the members of the audience to the advertisement delivery system for publication of the targeted information to the at least the portion of the members of the audience.

8. An identity management system comprising:
a processor; and
a memory that stores computer-executable instructions that, when executed by the processor, cause the processor to perform operations comprising:
providing, to a data management platform, a plurality of first identifiers and respective trait data associated with each of the plurality of first identifiers, wherein each of the plurality of first identifiers is associated with a respective account of a plurality of accounts managed by the identity management system, wherein the respective trait data associated with a first identifier of the plurality of first identifiers corresponds to a user associated with the respective account associated with the first identifier, and wherein a respective second identifier is assigned by the data management platform to each of the plurality of first identifiers,
receiving, from an advertisement delivery system, a plurality of third identifiers and corresponding first personal identifiable information associated with each of the plurality of third identifiers,
mapping, based on commonalities determined between the first personal identifiable information from the advertisement delivery system and second personal identifiable information associated with each of the plurality of accounts managed by the identity management system, each of the plurality of first identifiers with a respective one of the plurality of third identifiers to create a plurality of first identifier and third identifier pairs, and
providing, to the data management platform, the plurality of first identifier and third identifier pairs for use in creating a second bridge file comprising each corresponding second identifier paired to a respective one of the plurality of third identifiers according to the plurality of first identifiers.

9. The identity management system of claim 8, wherein providing the plurality of first identifiers to the data management platform comprises providing a file comprising at least a portion of the plurality of first identifiers to the data management platform.

10. The identity management system of claim 9, wherein the at least the portion of the plurality of first identifiers of the file is associated with a same type of account of the plurality of accounts.

11. The identity management system of claim 8, wherein the operations further comprise creating a first bridge file comprising each of the plurality of first identifier and third identifier pairs.

12. The identity management system of claim 11, wherein providing the plurality of first identifier and third identifier pairs to the data management platform comprises providing the first bridge file to the data management platform.

13. The identity management system of claim 8, wherein the operations further comprise:
collecting first-party data from a plurality of users associated with the plurality of accounts managed by the identity management system; and
deducing, based at least in part on the first-party data, the respective trait data associated with each of the plurality of users.

14. The identity management system of claim 8, wherein the data management platform determines, based at least in part on the respective trait data associated with each of the plurality of first identifiers, an audience to receive targeted information, wherein the data management platform uses the second bridge file to determine a respective third identifier for at least a portion of members of the audience, and wherein the data management platform provides the respective third identifier for each of the portion of the members of the audience to the advertisement delivery system for publication of the targeted information to the at least the portion of the members of the audience.

15. A computer-readable storage medium that stores computer-executable instructions that, when executed by a processor of an identity management system, cause the processor to perform operations comprising:
providing, to a data management platform, a plurality of first identifiers and respective trait data associated with each of the plurality of first identifiers, wherein each of the plurality of first identifiers is associated with a respective account of a plurality of accounts managed by the identity management system, wherein the respective trait data associated with a first identifier of the plurality of first identifiers corresponds to a user associated with the respective account associated with the first identifier, and wherein a respective second identifier is assigned by the data management platform to each of the plurality of first identifiers;
receiving, from an advertisement delivery system, a plurality of third identifiers and corresponding first personal identifiable information associated with each of the plurality of third identifiers;
mapping, based on commonalities determined between the first personal identifiable information from the advertisement delivery system and second personal identifiable information associated with each of the plurality of accounts managed by the identity management system, each of the plurality of first identifiers with a respective one of the plurality of third identifiers to create a plurality of first identifier and third identifier pairs; and
providing, to the data management platform, the plurality of first identifier and third identifier pairs for use in creating a second bridge file comprising each corresponding second identifier paired to a respective one of the plurality of third identifiers according to the plurality of first identifiers.

16. The computer-readable storage medium of claim 15, wherein providing the plurality of first identifiers to the data management platform comprises providing a file comprising at least a portion of the plurality of first identifiers to the data management platform.

17. The computer-readable storage medium of claim 16, wherein the at least the portion of the plurality of first identifiers of the file is associated with a same type of account of the plurality of accounts.

18. The computer-readable storage medium of claim 15, wherein the operations further comprise comprising creating a first bridge file comprising each of the plurality of first identifier and third identifier pairs.

19. The computer-readable storage medium of claim 18, wherein providing the plurality of first identifier and third identifier pairs to the data management platform comprises providing the first bridge file to the data management platform.

20. The computer-readable storage medium of claim 15, wherein the operations further comprise:
collecting first-party data from a plurality of users associated with the plurality of accounts managed by the identity management system; and
deducing, based at least in part on the first-party data, the respective trait data associated with each of the plurality of users.
